(19) United States
(12) Patent Application Publication
(10) Pub. No.: US 2017/0226273 A1
(43) Pub. Date: Aug. 10, 2017

(54) FLAME-RETARDANT POLYURETHANE MATERIALS

(71) Applicant: International Business Machines Corporation, Armonk, NY (US)

(72) Inventors: Sarah K. Czaplewski, Rochester, MN (US); Brandon M. Kobilka, Tucson, AZ (US); Joseph Kuczynski, North Port, FL (US); Jason T. Wertz, Pleasant Valley, NY (US); Jing Zhang, Poughkeepsie, NY (US)

(21) Appl. No.: 15/018,541

(22) Filed: Feb. 8, 2016

(51) Int. Cl. C08G 18/77; C08G 18/10; C08G 18/32

(52) U.S. Cl. CPC C08G 18/776; C08G 18/3206; C08G 18/10

(57) ABSTRACT

In an example, a process of forming a flame-retardant polyurethane material includes chemically reacting a polyisocyanate (that includes at least three isocyanate groups) with a phosphonate that includes at least one hydroxyl group to form a polyisocyanate-phosphonate compound. The process also includes forming a mixture that includes the polyisocyanate-phosphonate compound and a polyol. The process further includes polymerizing the mixture to form a flame-retardant polyurethane material.

### I. FIELD OF THE DISCLOSURE

The present disclosure relates generally to flame-retardant polyurethane materials.

### II. BACKGROUND

Plastics are typically derived from a finite and dwindling supply of petrochemicals, resulting in price fluctuations and supply chain instability. Replacing non-renewable petroleum-based polymers with polymers derived from renewable resources may be desirable. However, there may be limited alternatives to petroleum-based polymers in certain contexts. To illustrate, particular plastics performance standards may be specified by a standards body or by a regulatory agency. In some cases, alternatives to petroleum-based polymers may be limited as a result of challenges associated with satisfying particular plastics performance standards

### III. SUMMARY OF THE DISCLOSURE

According to an embodiment, a process of forming a flame-retardant polyurethane material includes chemically reacting a polyisocyanate (that includes at least three isocyanate groups) with a phosphonate that includes at least one hydroxyl group to form a polyisocyanate-phosphonate compound. The process also includes forming a mixture that includes the polyisocyanate-phosphonate compound and a polyol. The process further includes polymerizing the mixture to form a flame-retardant polyurethane material.

According to another embodiment, a process of forming a flame-retardant cross-linked polyurethane material is disclosed. The process includes chemically reacting a polyisocyanate that includes at least three isocyanate groups with a phosphonate that includes at least two hydroxyl groups to form a polyisocyanate-phosphonate compound. The process also includes forming a mixture that includes the polyisocyanate-phosphonate compound and a polyol. The process further includes polymerizing the mixture to form a flame-retardant cross-linked polyurethane material.

According to another embodiment, a flame-retardant polyurethane material is disclosed. The flame-retardant polyurethane material is formed by a process that includes chemically reacting a polyisocyanate that includes at least three isocyanate groups with a phosphonate that includes at least one hydroxyl group to form a polyisocyanate-phosphonate compound. The process also includes forming a mixture that includes the polyisocyanate-phosphonate compound and a polyol and polymerizing the mixture to form a flame-retardant cross-linked polyurethane material.

Features and other benefits that characterize embodiments are set forth in the claims annexed hereto and forming a further part hereof. However, for a better understanding of the embodiments, and of the advantages and objectives attained through their use, reference should be made to the Drawings and to the accompanying descriptive matter.

### IV. BRIEF DESCRIPTION OF THE DRAWINGS

FIG. 1 is a chemical reaction diagram showing a process of forming a flame-retardant polyurethane material that includes an organophosphate material chemically bound to a polymer chain, according to one embodiment;

FIG. 2A is a chemical reaction diagram showing a process of forming a polyisocyanate-phosphonate compound for use in forming a flame-retardant cross-linked polyurethane material that includes an organophosphate material chemically bound to a polymer chain, according to one embodiment;

FIG. 2B is a chemical reaction diagram showing a process of forming a polyisocyanate-phosphonate compound for use in forming a flame-retardant cross-linked polyurethane material that includes an organophosphate material chemically bound to a polymer chain, according to one embodiment;

FIG. 3 is a chemical reaction diagram showing a process of forming a flame-retardant cross-linked polyurethane material that includes an organophosphate material chemically bound to a polymer chain, according to one embodiment;

FIG. 4 is a chemical reaction diagram showing a process of forming a flame-retardant cross-linked polyurethane material that includes an organophosphate material chemically bound to a polymer chain, according to one embodiment;

FIG. 5 is a flow diagram showing a particular embodiment of a process of forming a flame-retardant polyurethane material that includes an organophosphate material chemically bound to a polymer chain; and

FIG. 6 is a flow diagram showing a particular embodiment of a process of forming a flame-retardant cross-linked polyurethane material that includes an organophosphate material chemically bound to a polymer chain.

### V. DETAILED DESCRIPTION

The present disclosure relates to flame-retardant polyurethane materials (including flame-retardant cross-linked polyurethane materials) and processes for forming the flame-retardant polyurethane materials. In the present disclosure, a polyisocyanate that includes at least three isocyanate groups may be chemically reacted with a phosphonate that includes at least one hydroxyl group to form a polyisocyanate-phosphonate compound. A mixture that includes the polyisocyanate-phosphonate compound and a polyol may be polymerized to form a flame-retardant polyurethane material having an organophosphate material chemically bound to a polymer chain.

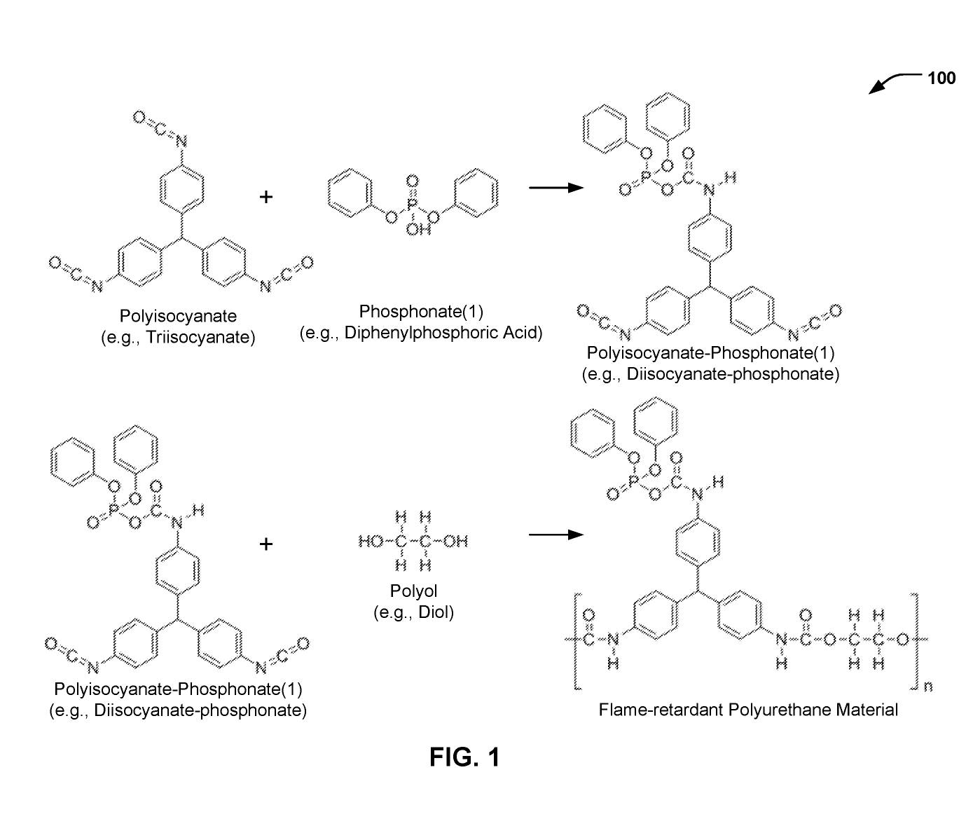

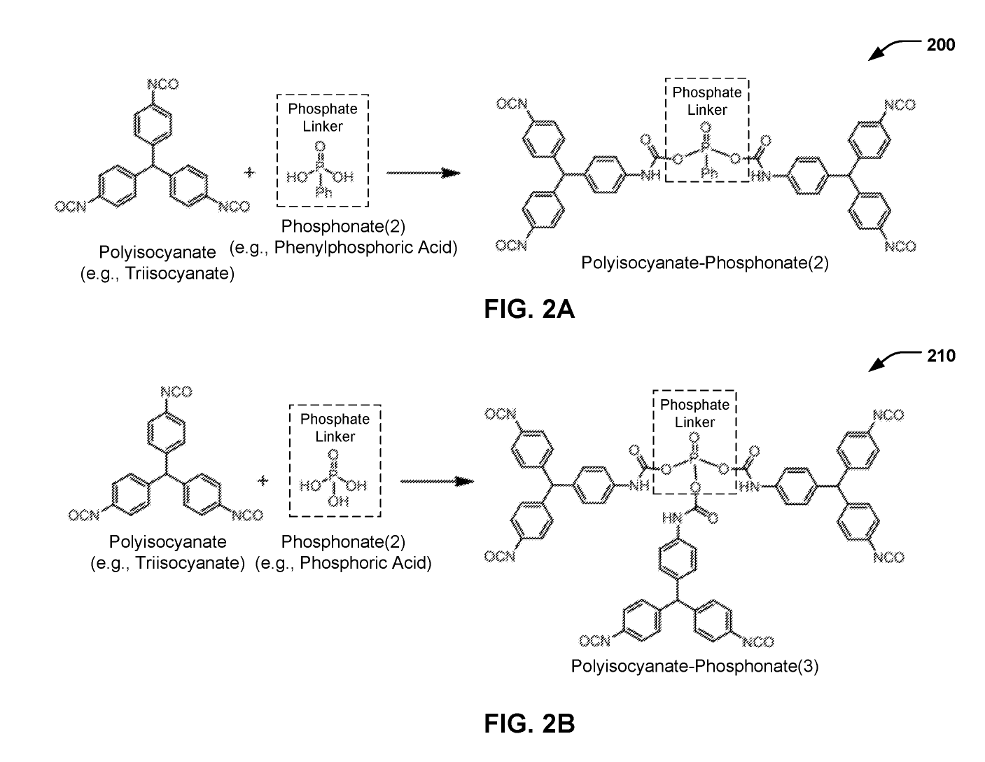

In some cases, as illustrated and described herein with respect to FIG. 1, the phosphonate may have one hydroxyl group (e.g., diphenylphosporic acid), and polymerization of an associated polyisocyanate-phosphonate with a polyol may result in a flame-retardant polyurethane material with a pendant phosphonate group. In other cases, as illustrated and described further herein with respect to FIGS. 2-4, the phosphonate may have at least two hydroxyl groups (e.g., phenylphosphoric acid and/or phosphoric acid), with the additional hydroxyl group(s) representing potential cross-linking locations for formation of flame-retardant cross-linked polyurethane materials. By chemically binding an organophosphate material to a polymer chain, the polyurethane materials formed according to the processes described herein may be rendered flame-retardant without the addition of halogen-containing flame retardant additives.

Referring to FIG. 1, a chemical reaction diagram 100 illustrates the preparation of a flame-retardant polyurethane material that includes an organophosphate material chemically bound to a polymer chain, according to one embodiment. The first chemical reaction (proceeding from top to bottom) shown in FIG. 1 illustrates a chemical reaction of a polyisocyanate (or a mixture of polyisocyanates) having at least three isocyanate groups (e.g., a triisocyanate) with diphenylphosphoric acid (also referred to as diphenyl phosphate) to form a polyisocyanate-phosphonate compound (e.g., a diisocyanate-phosphonate compound). The second chemical reaction shown in FIG. 1 illustrates that the polyisocyanate-phosphonate compound formed in the first chemical reaction may be chemically reacted with a polyol (or a mixture of polyols) to form a flame-retardant polyurethane material.

In the particular embodiment illustrated in FIG. 1, the polyisocyanate includes tris-4-(isocyanatophenyl)methane. In some cases, alternative and/or additional polyisocyanates that includes at least three isocyanate groups may be used. In the particular embodiment illustrated in FIG. 1, the phosphonate that includes at least one hydroxyl group (identified as “Phosphonate(1)” in FIG. 1) includes diphenylphosphoric acid. In some cases, alternative and/or additional phosphonates that include at least one hydroxyl group may be used. The first chemical reaction of FIG. 1 illustrates that the chemical reaction of the polyisocyanate and the phosphonate results in a polyisocyanate-phosphonate (identified as “Polyisocyanate-Phosphonate(1)” in FIG. 1). In the example of FIG. 1, where the polyisocyanate includes a triisocyanate and the phosphonate includes a single hydroxyl group, the chemical reaction results in the formation of a diisocyanate-phosphonate.

In a particular embodiment, the polyisocyanate may be in “slight excess” with respect to the phosphonate in order to allow for bonding of the hydroxyl group of the phosphonate in the reaction mixture. For example, the slight excess may correspond to an additional 0.5 weight percent to 2 weight percent in order to ensure that excess isocyanate groups are available for forming a polyurethane when reacted with a polyol (e.g., a diol). A degree of substitution can be controlled by varying a quantity of the phosphonate in the reaction mixture. The reaction may be carried out in a suitable solvent.

The second chemical reaction of FIG. 1 illustrates that the polyisocyanate-phosphonate formed in the first chemical reaction may be reacted with a polyol (or a mixture of polyols) to form a flame-retardant polyurethane material that includes a non-halogenated organophosphate material chemically bound to a polymer chain. In the example of FIG. 1, the polyol includes a diol, such as ethylene glycol. In other cases, alternative and/or additional polyols may be used. For example, propane 1,2,3-triol or a castor-oil derived diol may be utilized (among other alternatives).

The flame-retardant polyurethane material may be fabricated into a desired geometry, with the end result being a flame-retardant article. In some cases, the flame-retardant polyurethane material formed according to the process described with respect to FIG. 1 may be used to form a flame-retardant article that has flame retardancy characteristics that satisfy one or more plastics flammability standards, such as the Underwriters Laboratories® (UL) 94 HB flammability standard. In some cases, the flame-retardant polyurethane material of FIG. 1 may be blended with one or more other polymeric materials to form a polymeric blend that satisfies the plastics flammability standard(s). In a particular embodiment, the flame-retardant polyurethane material of FIG. 1 may be not greater than 10 weight percent of the polymeric blend.

In a particular embodiment, the flame-retardant polyurethane material formed according to the process illustrated in FIG. 1 may be used as a component of an acoustic dampening foam (e.g., for mainframe servers). For example, an acoustic dampening foam may include flame-retardant polyurethane material of FIG. 1 and a second polyurethane material. A weight percentage of the flame-retardant polyurethane material may be not greater than 10 weight percent of the acoustic dampening foam. The weight percentage may be adjusted based on desired mechanical properties for the acoustic dampening foam. Illustrative, non-limiting examples of desired material properties may include a density of about 2 pounds per cubic foot, a pore count of about 65-75 pores per inch, and a sustainable material content of at least 10 weight percent. In the context of fabric-over-foam gaskets, a desired material property may be a compression set of less than 5 percent following compression to 50 percent of an initial thickness.

### Example: Formation of a Flame-Retardant Polyurethane Material

A polyisocyanate having at least three isocyanate groups, such as tris-4-(isocyanatophenyl)methane, and a phosphonate having at least one hydroxyl group, such as diphenylphosphoric acid, may be mixed in a reaction vessel. The polyisocyanate may be 0.5 to 1.5 molar equivalents relative to the diphenylphosphoric acid. The two compounds may be reacted in organic solvents such as THF, DCM, toluene, etc., and the reaction may be carried out at temperatures above or below room temperature. The reaction may be carried out in an inert atmosphere and may use anhydrous solvents. A resulting polyisocyanate-phosphonate product may be isolated by removal of the solvents, recrystallization or other techniques.

The polyisocyanate-phosphonate compound may then be used to synthesize polyurethane materials via a chemical reaction with a polyol or mixture of polyols (that can be derived from petroleum-based sources or biorenewable sources to increase a renewable carbon content). The ratios of the compounds, reactions times, and reactions conditions can be varied to control an amount of cross-linking in the resulting materials. Water can be added to the blends to synthesize polyurethane foam-based materials. Reaction conditions may be varied depending on the desired properties of the final materials.

Thus, FIG. 1 illustrates an example of a process of forming a flame-retardant polyurethane material that includes an organophosphate material chemically bound to a polymer chain. In the example of FIG. 1, a polyisocyanate having at least three isocyanate groups (e.g., a triisocyanate) is chemically reacted with a phosphonate having a single hydroxyl group (e.g., diphenylphosphoric acid) to form a polyisocyanate-phosphonate compound. The resulting polyisocyanate-phosphonate compound may be reacted with a polyol or mixture of polyols (e.g., a diol or a mixture of diols) to form the flame-retardant polyurethane material depicted in FIG. 1. In some cases, the flame-retardant polyurethane material of FIG. 1 may be used as a component of an acoustic dampening foam (e.g., for mainframe servers), among other possibilities in a wide range of polyurethane material applications.

Referring to FIG. 2A, a chemical reaction diagram 200 illustrates the preparation of an example of a polyisocyanate-phosphonate compound that may be used as a monomer, an oligomer, or a pre-polymer. As described further herein, in some cases, the polyisocyanate-phosphonate compound of FIG. 2A can be reacted with a polyol (or a mixture of polyols) to form a flame-retardant polyurethane material containing a covalently-bound organophosphate material in a polymer chain.

In the chemical reaction of FIG. 2A, a polyisocyanate (or a mixture of polyisocyanates) having at least three isocyanate groups (e.g., a triisocyanate) chemically reacts with a phosphonate having two hydroxyl groups (e.g., phenylphosphoric acid) to form a polyisocyanate-phosphonate compound (identified as “Polyisocyanate-Phosphonate(2)” in FIG. 2A). FIG. 2A illustrates that the two hydroxyl groups of a phosphonate molecule function as a phosphate linker (identified via dashed lines), with each of the two hydroxyl groups chemically reacting with one of the isocyanate groups of a polyisocyanate molecule to link two polyisocyanate molecules together.

While not shown in the example of FIG. 2A, the polyisocyanate-phosphonate compound may be chemically reacted with a polyol (e.g., a diol, such as ethylene glycol) to form a flame-retardant polyurethane material. Both a degree of flame retardancy and physical properties of the flame-retardant polyurethane material may be controlled by varying the molar ratios and molecular structures of the reactant materials. To illustrate, in the example of FIG. 2A, a degree of flame retardancy may be controlled by varying the molar ratios of the polyisocyanate(s) that include at least three isocyanate groups and the phosphonate(s) that include two hydroxyl groups, as well as a molar ratio and/or a molecular structure of polyol(s) that are subsequently reacted with the polyisocyanate-phosphonate(s) to form a flame-retardant polyurethane material.

### Example: Formation of a Polyisocyanate-Phosphonate Compound

A polyisocyanate having at least three isocyanate groups, such as tris-4-(isocyanatophenyl)methane, and a phosphonate having at least two hydroxyl groups, such as phenylphosphoric acid, may be mixed in a reaction vessel. The polyisocyanate may be 0.5 or less molar equivalents relative to the phenylphosphoric acid. The two compounds may be reacted in organic solvents such as THF, DCM, toluene, etc., and the reaction may be carried out at temperatures above or below room temperature. The reaction may be carried out in an inert atmosphere and may use anhydrous solvents. A resulting polyisocyanate-phosphonate product may be isolated by removal of the solvents, recrystallization or other techniques.

Thus, FIG. 2A illustrates an example of a process of forming a polyisocyanate-phosphonate compound that may be used to form a flame-retardant cross-linked polyurethane material that includes an organophosphate material chemically bound to a polymer chain. In the example of FIG. 2A, a polyisocyanate having at least three isocyanate groups (e.g., a triisocyanate) is chemically reacted with a phosphonate having two hydroxyl groups (e.g., phenylphosphoric acid) to form a polyisocyanate-phosphonate compound. While not shown in the example of FIG. 2A, the resulting polyisocyanate-phosphonate compound may be reacted with a polyol or mixture of polyols (e.g., a diol or a mixture of diols) to form a flame-retardant cross-linked polyurethane material (with a variable degree of cross-linking).

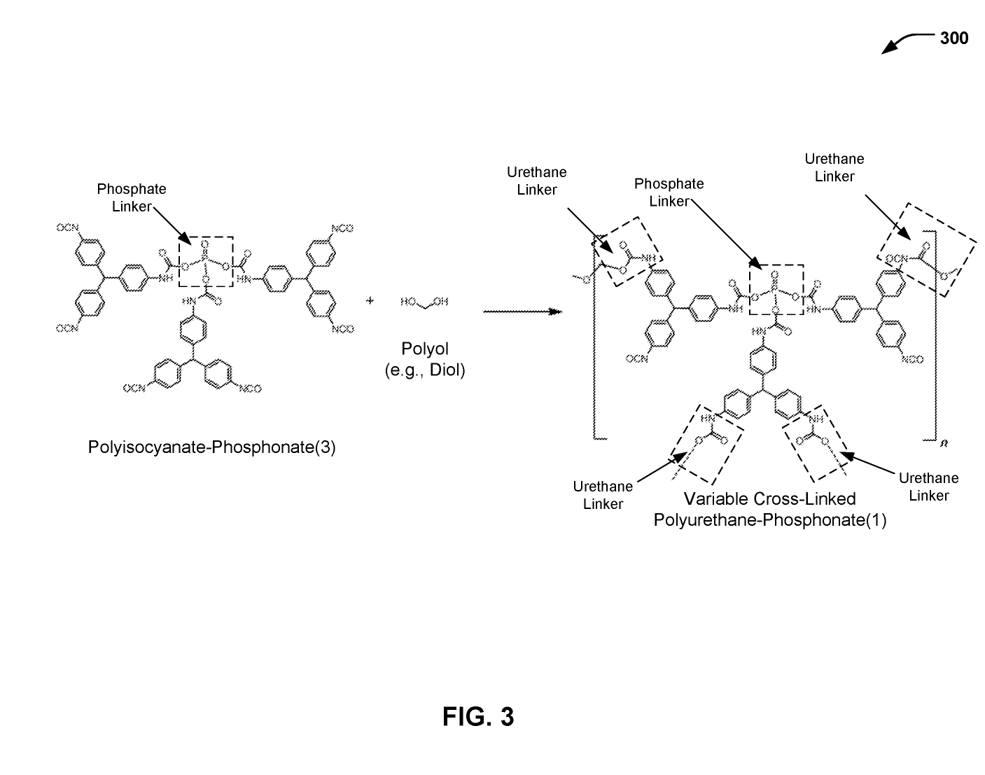

Referring to FIG. 2B, a chemical reaction diagram 210 illustrates the preparation of another example of a polyisocyanate-phosphonate compound that may be used as a monomer, an oligomer, or a pre-polymer. As described further herein with respect to FIG. 3, in some cases, the polyisocyanate-phosphonate compound of FIG. 2B can be reacted with a polyol (or a mixture of polyols) to form a flame-retardant polyurethane material containing a covalently-bound organophosphate material in a polymer chain.

In the chemical reaction of FIG. 2B, a polyisocyanate (or a mixture of polyisocyanates) having at least three isocyanate groups (e.g., a triisocyanate) chemically reacts with a phosphonate having three hydroxyl groups (e.g., phosphoric acid) to form a polyisocyanate-phosphonate compound (identified as “Polyisocyanate-Phosphonate(3)” in FIG. 2B). FIG. 2B illustrates that the three hydroxyl groups of a phosphonate molecule function as a phosphate linker (identified via dashed lines), with each of the three hydroxyl groups chemically reacting with one of the isocyanate groups of a polyisocyanate molecule to link three polyisocyanate molecules together.

As illustrated and further described herein with respect to FIG. 3, the polyisocyanate-phosphonate compound may be chemically reacted with a polyol (e.g., a diol, such as ethylene glycol) to form a flame-retardant polyurethane material. Both a degree of flame retardancy and physical properties of the flame-retardant polyurethane material may be controlled by varying the molar ratios and molecular structures of the reactant materials. To illustrate, in the example of FIG. 2B, a degree of flame retardancy may be controlled by varying the molar ratios of the polyisocyanate(s) that include at least three isocyanate groups and the phosphonate(s) that include three hydroxyl groups, as well as a molar ratio and/or a molecular structure of polyol(s) that are subsequently reacted with the polyisocyanate-phosphonate(s) to form a flame-retardant polyurethane material.

### Example: Formation of a Polyisocyanate-Phosphonate Compound

A polyisocyanate, such as tris-4-(isocyanatophenyl)methane, and a phosphonate, such as phosphoric acid, may be mixed in a reaction vessel. The polyisocyanate may be 0.33 or less molar equivalents relative to the phosphoric acid. The two compounds may be reacted in organic solvents such as THF, DCM, toluene, etc., and the reaction may be carried out at temperatures above or below room temperature. The reaction may be carried out in an inert atmosphere and may use anhydrous solvents. A resulting polyisocyanate-phosphonate product may be isolated by removal of the solvents, recrystallization or other techniques.

Thus, FIG. 2B illustrates an example of a process of forming a polyisocyanate-phosphonate compound that may be used to form a flame-retardant cross-linked polyurethane material that includes an organophosphate material chemically bound to a polymer chain. In the example of FIG. 2B, a polyisocyanate having at least three isocyanate groups (e.g., a triisocyanate) is chemically reacted with a phosphonate having three hydroxyl groups (e.g., phosphoric acid) to form a polyisocyanate-phosphonate compound. As illustrated and further described herein with respect to FIG. 3, the resulting polyisocyanate-phosphonate compound may be reacted with a polyol or mixture of polyols (e.g., a diol or a mixture of diols) to form a flame-retardant cross-linked polyurethane material (with a variable degree of cross-linking).

Referring to FIG. 3, a chemical reaction diagram 300 illustrates the preparation of a flame-retardant cross-linked polyurethane material that includes an organophosphate material chemically bound to a polymer chain, according to one embodiment. In the chemical reaction depicted in FIG. 3, a polyisocyanate-phosphonate compound is chemically reacted with a polyol to form a variable cross-linked polyurethane material (identified as “Variable Cross-Linked Polyurethane-Phosphonate(1)” in FIG. 3). In a particular embodiment, the polyisocyanate-phosphonate of FIG. 3 (identified as “Polyisocyanate-Phosphonate(3)”) may be formed according to the process described herein with respect to FIG. 2B.

FIG. 3 illustrates that the polyisocyanate-phosphonate compound may be reacted with a polyol (or a mixture of polyols) to form a cross-linked flame-retardant polyurethane material that includes a non-halogenated organophosphate material chemically bound to a polymer chain. In the example of FIG. 3, the polyol includes a diol, such as ethylene glycol. In other cases, alternative and/or additional polyols may be used. For example, propane 1,2,3-triol or a castor-oil derived diol may be utilized (among other alternatives).

FIG. 3 illustrates (via dashed lines) the presence of the phosphate linker of the polyisocyanate-phosphonate compound in the cross-linked polyurethane-phosphonate as well as the presence of urethane linkers associated with the chemical reaction of the hydroxyl groups of the polyol with a subset of the remaining isocyanate groups of the polyisocyanate-phosphonate compound. In the particular embodiment of FIG. 3, four cross-linking locations are illustrated, with two of the cross-linking locations corresponding to chemical reactions of one isocyanate group of the two remaining isocyanate groups for two phosphate-linked polyisocyanates. The two other cross-linking locations correspond to chemical reactions of both remaining isocyanate groups of one phosphate-linked polyisocyanate. It will be appreciated that the example of FIG. 3 is for illustrative purposes only and that other cross-linking arrangements may result in other cases.

The cross-linked flame-retardant polyurethane material of FIG. 3 may be fabricated into a desired geometry, with the end result being a flame-retardant article. In some cases, the cross-linked flame-retardant polyurethane material formed according to the process described with respect to FIG. 3 may be used to form a flame-retardant article that has flame retardancy characteristics that satisfy one or more plastics flammability standards, such as the UL 94 HB flammability standard. In some cases, the cross-linked flame-retardant polyurethane material of FIG. 3 may be blended with one or more other polymeric materials to form a polymeric blend that satisfies the plastics flammability standard(s). In a particular embodiment, the flame-retardant polyurethane material of FIG. 3 may be not greater than 10 weight percent of the polymeric blend.

In a particular embodiment, the flame-retardant cross-linked polyurethane material formed according to the process illustrated in FIG. 3 may be used as a component of an acoustic dampening foam (e.g., for mainframe servers). For example, an acoustic dampening foam may include the flame-retardant cross-linked polyurethane material of FIG. 3 and a second polyurethane material. A weight percentage of the flame-retardant cross-linked polyurethane material may be not greater than 10 weight percent of the acoustic dampening foam. The weight percentage may be adjusted based on desired mechanical properties for the acoustic dampening foam. Illustrative, non-limiting examples of desired material properties may include a density of about 2 pounds per cubic foot, a pore count of about 65-75 pores per inch, and a biological content of at least 10 weight percent. In the context of fabric-over-foam gaskets, a desired material property may be a compression set of less than 5 percent following compression to 50 percent of an initial thickness.

### Example: Formation of a Flame-Retardant Cross-Linked Polyurethane Material

The polyisocyanate-phosphonate compound illustrated in the example of FIG. 2B may be formed as previously described herein. The polyisocyanate-phosphonate compound may then be used to synthesize polyurethane material(s) via reactions with a polyol or mixture of polyols (which may be derived from petroleum-based sources or biorenewable sources to increase a renewable carbon content). The ratios of the compounds can be varied to control an amount of cross-linking in the resulting materials. Water can be added to the blends to synthesize polyurethane foam-based materials. Reaction conditions can be varied depending on the desired properties of the final materials.

Thus, FIG. 3 illustrates an example of a process of forming a cross-linked flameretardant polyurethane material via a chemical reaction of a polyisocyanate-phosphonate compound (e.g., the polyisocyanate-phosphonate compound of FIG. 2B) and a polyol (or polyols). Adjusting reaction stoichiometry and/or reaction conditions may enable a degree of cross-linking to be varied, depending on the desired properties for the cross-linked flame-retardant polyurethane material.

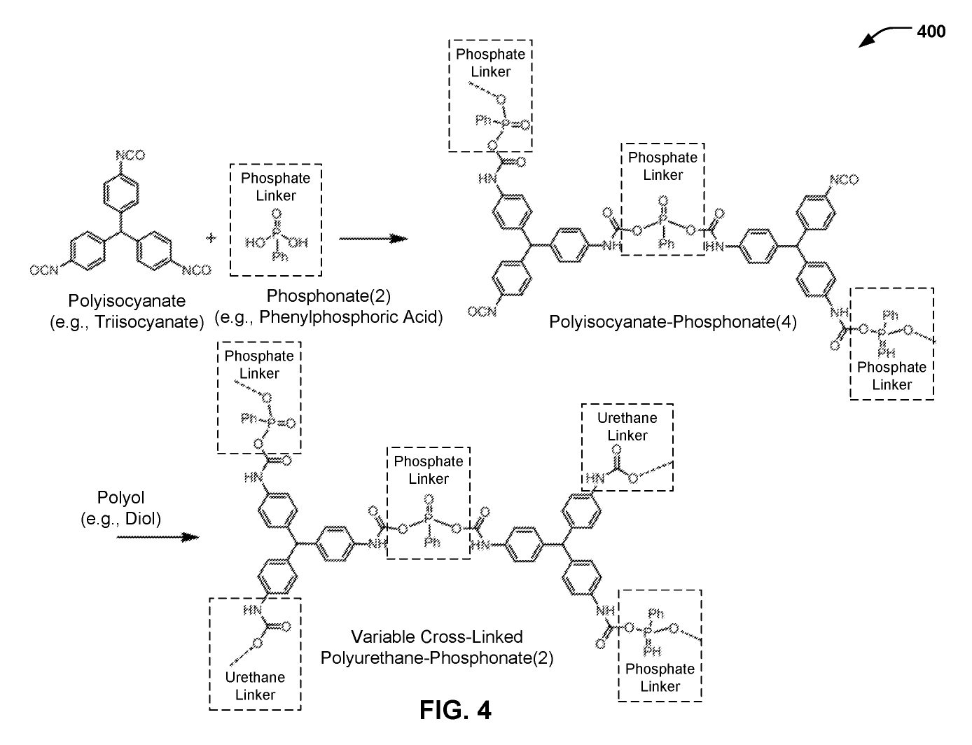

Referring to FIG. 4, a chemical reaction diagram 400 illustrates the preparation of a flame-retardant cross-linked polyurethane material that includes an organophosphate material chemically bound to a polymer chain, according to one embodiment. The first chemical reaction results in the formation of a polyisocyanate-phosphonate compound (identified as “Polyisocyanate-Phosphonate(4)” in FIG. 4). The second chemical reaction shown in FIG. 4 illustrates that the polyisocyanate-phosphonate compound formed in the first chemical reaction may be chemically reacted with a polyol (or a mixture of polyols) to form a flame-retardant cross-linked polyurethane material.

FIG. 4 illustrates (via dashed lines) the presence of the phosphate linker at three locations in the polyisocyanate-phosphonate compound. In contrast to the polyisocyanate-phosphonate of FIG. 2A in which (on average) a single isocyanate group of the polyisocyanate reacts with a hydroxyl group of the phosphonate material (resulting in a single phosphate linkage), the polyisocyanate-phosphonate of FIG. 4 includes (on average) two isocyanate groups of the polyisocyanate reacting with hydroxyl groups of the phosphonate material (resulting in three phosphate linkages).

The second chemical reaction of FIG. 4 illustrates that the polyisocyanate-phosphonate formed in the first chemical reaction may be reacted with a polyol (or a mixture of polyols) to form a flame-retardant polyurethane material that includes a non-halogenated organophosphate material chemically bound to a polymer chain (identified as “Variable Cross-Linked Polyurethane-Phosphonate(2)” in FIG. 4). In the example of FIG. 4, the polyol includes a diol, such as ethylene glycol. In other cases, alternative and/or additional polyols may be used. For example, propane 1,2,3-triol or a castor-oil derived diol may be utilized (among other alternatives).

FIG. 4 illustrates (via dashed lines) the presence of the three phosphate linkers of the polyisocyanate-phosphonate compound in the cross-linked polyurethane-phosphonate as well as the presence of urethane linkers associated with the chemical reaction of the hydroxyl groups of the polyol with a subset of the remaining isocyanate groups of the polyisocyanate-phosphonate compound. In the particular embodiment of FIG. 4, two urethane cross-linking locations are illustrated, with the cross-linking locations corresponding to chemical reactions of the remaining isocyanate groups of the polyisocyanate-phosphonate compound. It will be appreciated that the example of FIG. 4 is for illustrative purposes only and that other cross-linking arrangements may result in other cases.

The cross-linked flame-retardant polyurethane material of FIG. 4 may be fabricated into a desired geometry, with the end result being a flame-retardant article. In some cases, the cross-linked flame-retardant polyurethane material formed according to the process described with respect to FIG. 4 may be used to form a flame-retardant article that has flame retardancy characteristics that satisfy one or more plastics flammability standards, such as the UL 94 HB flammability standard. In some cases, the cross-linked flame-retardant polyurethane material of FIG. 4 may be blended with one or more other polymeric materials to form a polymeric blend that satisfies the plastics flammability standard(s). In a particular embodiment, the flame-retardant polyurethane material of FIG. 4 may be not greater than 10 weight percent of the polymeric blend.

In a particular embodiment, the flame-retardant cross-linked polyurethane material formed according to the process illustrated in FIG. 4 may be used as a component of an acoustic dampening foam (e.g., for mainframe servers). For example, an acoustic dampening foam may include the flame-retardant cross-linked polyurethane material of FIG. 4 and a second polyurethane material. A weight percentage of the flame-retardant cross-linked polyurethane material may be not greater than 10 weight percent of the acoustic dampening foam. The weight percentage may be adjusted based on desired mechanical properties for the acoustic dampening foam. Illustrative, non-limiting examples of desired material properties may include a density of about 2 pounds per cubic foot, a pore count of about 65-75 pores per inch, and a sustainable material content of at least 10 weight percent. In the context of fabric-over-foam gaskets, a desired material property may be a compression set of less than 5 percent following compression to 50 percent of an initial thickness.

### Example: Formation of a Flame-Retardant Cross-Linked Polyurethane Material

A polyisocyanate, such as tris-4-(isocyanatophenyl)methane, and a phosphonate, such as phenylphosphoric acid, may be mixed in a reaction vessel. The polyisocyanate may be 0.8 to 1.2 molar equivalents relative to the phenylphosphoric acid. The two compounds may be reacted in organic solvents such as THF, DCM, toluene, etc., and the reaction may be carried out at temperatures above or below room temperature. The reaction may be carried out in an inert atmosphere and may use anhydrous solvents. The product may be isolated by removal of the solvents, precipitation, recrystallization, Soxhlet extraction or by other techniques.

Thus, FIG. 4 illustrates an example of a process of forming a cross-linked flame-retardant polyurethane material via a chemical reaction of a polyisocyanate-phosphonate compound and a polyol (or polyols). In contrast to the polyisocyanate-phosphonate of FIG. 2A in which (on average) a single isocyanate group of the polyisocyanate reacts with a hydroxyl group of the phosphonate material (resulting in a single phosphate linkage), the polyisocyanate-phosphonate of FIG. 4 includes (on average) two isocyanate groups of the polyisocyanate reacting with hydroxyl groups of the phosphonate material (resulting in three phosphate linkages). Adjusting reaction stoichiometry and/or reaction conditions may enable a degree of cross-linking to be varied, depending on the desired properties for the cross-linked flame-retardant polyurethane material.

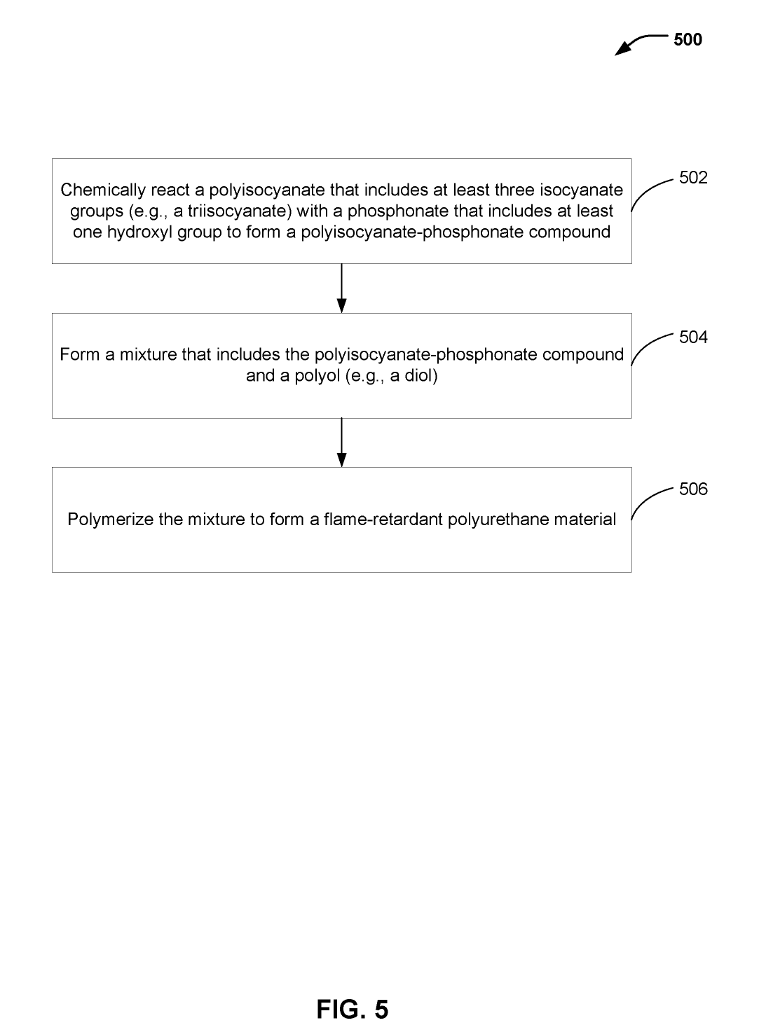

Referring to FIG. 5, a flow diagram illustrates a process 500 of forming a flame-retardant polyurethane material that includes an organophosphate material covalently bonded to a polymer chain, according to an embodiment.

The process 500 includes chemically reacting a polyisocyanate that includes at least three isocyanate groups with a phosphonate to form a polyisocyanate-phosphonate compound, at 502. For example, referring to FIG. 1, the polyisocyanate includes a triisocyanate, and the phosphonate includes one hydroxyl group. In the first chemical reaction illustrated in the example of FIG. 1, the triisocyanate chemically reacts with the polyisocyanate to form a polyisocyanate-phosphonate compound (identified as “Polyisocyanate-Phosphonate(1)” in FIG. 1).

The process 500 includes forming a mixture that includes the polyisocyanate-phosphonate compound and a polyol, at 504. For example, referring to FIG. 1, the polyisocyanate-phosphonate compound formed in the first chemical reaction may be mixed with a polyol (e.g., a diol, such as ethylene glycol).

The process 500 includes polymerizing the mixture to form a flame-retardant polyurethane material, at 506. For example, referring to the second chemical reaction of FIG. 1, the mixture of the polyisocyanate-phosphonate and the polyol may be polymerized to form the flame-retardant polyurethane material. As shown in the example of FIG. 1, the resulting flame-retardant polyurethane material includes an organophosphate material covalently bonded to a polymer chain.

Thus, FIG. 5 illustrates an example of a process of forming a flame-retardant polyurethane material that includes an organophosphate material covalently bonded to a polymer chain. As further described herein, the flame-retardant polyurethane material may be used to form a flame-retardant article that satisfies one or more plastics flammability standards (e.g., the UL 94 HB flammability standard).

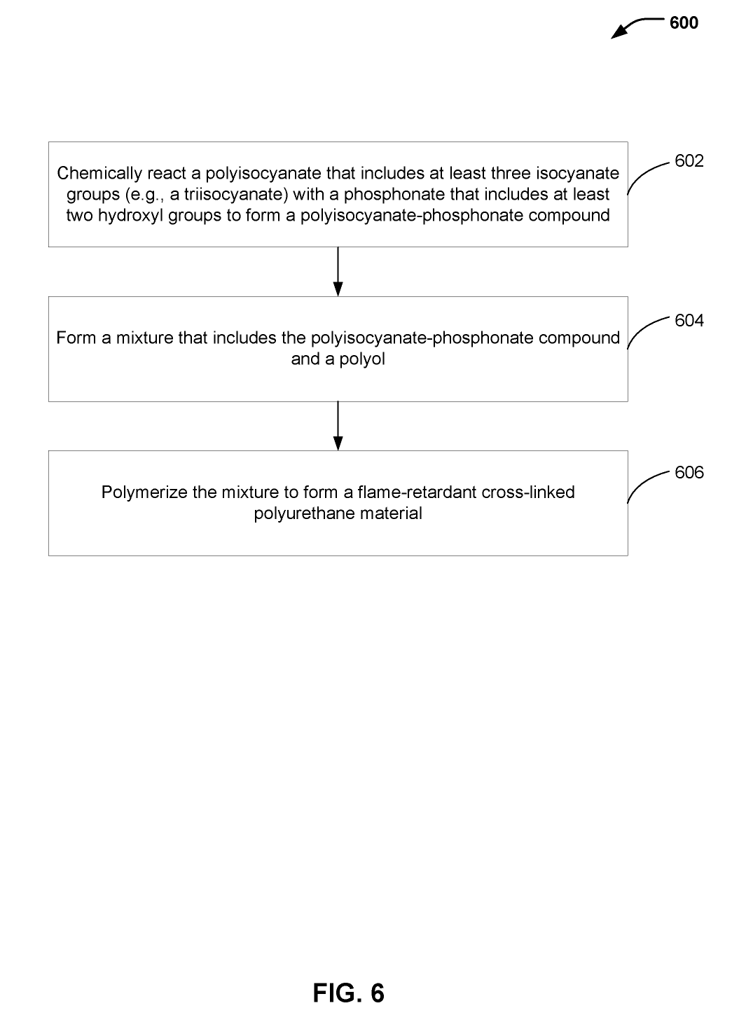

Referring to FIG. 6, a flow diagram illustrates a process 600 of forming a flame-retardant cross-linked polyurethane material that includes an organophosphate material covalently bonded to a polymer chain, according to an embodiment.

The process 600 includes chemically reacting a polyisocyanate that includes at least three isocyanate groups with a phosphonate to form a polyisocyanate-phosphonate compound, at 602. In the particular embodiment illustrated in FIG. 6, the phosphonate includes at least two hydroxyl groups.

For example, referring to FIG. 2A, the polyisocyanate may include a triisocyanate, and the phosphonate (e.g., phenylphosphoric acid) may include two hydroxyl groups. FIG. 2A illustrates that the triisocyanate chemically reacts with the polyisocyanate to form a polyisocyanate-phosphonate compound (identified as “Polyisocyanate-Phosphonate(2)” in FIG. 2A).

As another example, referring to FIG. 2B, the polyisocyanate may include a triisocyanate, and the phosphonate (e.g., phosphoric acid) may include three hydroxyl groups. FIG. 2B illustrates that the triisocyanate chemically reacts with the polyisocyanate to form a polyisocyanate-phosphonate compound (identified as “Polyisocyanate-Phosphonate(3)” in FIG. 2B).

As a further example, referring to FIG. 4, the polyisocyanate may include a triisocyanate, and the phosphonate (e.g., phenylphosphoric acid) may include two hydroxyl groups. FIG. 4 illustrates that the triisocyanate chemically reacts with the polyisocyanate to form a polyisocyanate-phosphonate compound (identified as “Polyisocyanate-Phosphonate(4)” in FIG. 4).

The process 600 includes forming a mixture that includes the polyisocyanate-phosphonate compound and a polyol, at 604. For example, the polyisocyanate-phosphonate compound of FIG. 2A may be mixed with a polyol. As another example, the polyisocyanate-phosphonate compound of FIG. 2B may be mixed with a polyol. As a further example, the polyisocyanate-phosphonate compound of FIG. 4 may be mixed with a polyol.

The process 600 includes polymerizing the mixture to form a flame-retardant cross-linked polyurethane material, at 606.

For example, referring to FIG. 3, the mixture of the polyisocyanate-phosphonate compound and the polyol may be polymerized to form the cross-linked polyurethane-phosphonate material (identified as “Variable Cross-Linked Polyurethane-Phosphonate(1)” in FIG. 3). As shown in the example of FIG. 3, the resulting flame-retardant cross-linked polyurethane material includes an organophosphate material covalently bonded to a polymer chain.

As another example, referring to the second chemical reaction of FIG. 4, the mixture of the polyisocyanate-phosphonate compound and the polyol may be polymerized to form the cross-linked polyurethane-phosphonate material (identified as “Variable Cross-Linked Polyurethane-Phosphonate(2)” in FIG. 4). As shown in the example of FIG. 4, the resulting flame-retardant cross-linked polyurethane material includes an organophosphate material covalently bonded to a polymer chain.

Thus, FIG. 6 illustrates an example of a process of forming a flame-retardant cross-linked polyurethane material that includes an organophosphate material covalently bonded to a polymer chain. As further described herein, the flame-retardant cross-linked polyurethane material may be used to form a flame-retardant article that satisfies one or more plastics flammability standards (e.g., the UL 94 HB flammability standard).

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

1. A process of forming a flame-retardant polyurethane material, the process comprising:
chemically reacting a triisocyanate with a phosphonate to form a phosphate linked polyisocyanate compound;
forming a mixture that includes the phosphate linked polyisocyanate compound and a polyol; and
polymerizing the mixture to form a flame-retardant polyurethane material.

2-3. (canceled)

4. The process of claim 3, wherein the triisocyanate include tris-4-(isocyanatophenyl)methane.

5. The process of claim 1, wherein the polyol includes a diol.

6. The process of claim 5, wherein the diol includes ethylene glycol.

7. A process of forming a flame-retardant cross-linked polyurethane material, the process comprising:
chemically reacting a triisocyanate with a phosphonate to form an isocyanate phosphate copolymer;
forming a mixture that includes the isocyanate phosphate copolymer and a polyol; and
polymerizing the mixture to form a flame-retardant cross-linked polyurethane material.

8. The process of claim 7, wherein the phosphonate includes phenyl phosphoric acid.

9. The process of claim 8, wherein the polyol includes phenyl phosphoric acid.

10. The process of claim 7, wherein the phosphonate includes phosphoric acid.

11. The process of claim 10, wherein the polyol includes a diol.

12. (canceled)

13. A flame-retardant polyurethane material formed by a process that includes:
chemically reacting a triisocyanate with a phosphonate to form a phosphate linked polyisocyanate compound;
forming a mixture that includes the phosphate linked polyisocyanate compound and a polyol; and
polymerizing the mixture to form a flame-retardant polyurethane material.

14-15. (canceled)

16. The flame-retardant polyurethane material of claim 13, wherein the polyol includes a diol.

17. The flame-retardant polyurethane material of claim 13, wherein the phosphonate includes phenylphosphoric acid, and wherein the flame-retardant polyurethane material includes a flame-retardant cross-linked polyurethane material.

18. The flame-retardant polyurethane material of claim 17, wherein the polyol includes phenylphosphoric acid.

19. The flame-retardant polyurethane material of claim 13, wherein the phosphonate includes phosphoric acid, and wherein the flame-retardant polyurethane material includes a flame-retardant cross-linked polyurethane material.

20. The flame-retardant polyurethane material of claim 19, wherein the polyol includes a diol.

21. The flame-retardant polyurethane material of claim 13, wherein the phosphate linked polyisocyanate compound is an isocyanate-phosphate copolymer.
